(19) United States
(12) Patent Application Publication
(10) Pub. No.: US 2007/0089827 A1
(43) Pub. Date: Apr. 26, 2007

(54) METHOD FOR PRODUCING AN OPTICAL ELEMENT

(75) Inventor: Shiro FUNATSU, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS CO., LTD., Tokyo (JP)

(21) Appl. No.: 11/565,829

(22) Filed: Dec. 1, 2006

Related U.S. Application Data
(63) Continuation of application No. PCT/JP05/09562, filed on May 25, 2005.

(30) Foreign Application Priority Data
Jun. 1, 2004 (JP) 2004-163103

(51) Int. Cl. B32B 17/10

(52) U.S. Cl. 156/99

(57) ABSTRACT

A method for producing an optical element by bonding a plurality of optical member with an adhesive, which is capable of providing the optical element with sufficient optical performance and with such a sufficient bonding strength to prevent separation from being made at bonded portions, and of making alignment easily, is provided. The method for producing an optical element, which comprises bonding two or more optical members with an adhesive, is characterized in that at least one of confronting bonded surfaces on at least one pair of contact surfaces of the optical members is subjected to dry cleaning in such a state that at least a surface connecting to a bonded surface is masked, followed by applying a liquid adhesive as the adhesive on the cleaned surface and curing the liquid adhesive to bond the optical members.

### BACKGROUND OF THE INVENTION

1. Field of the Invention

The present invention relates to a method for producing an optical element by bonding a plurality of optical members with an adhesive.

2. Discussion of Background

In a method for producing an optical element, such as a cemented lens) by bonding a plurality of optical members with an adhesive, if optical members are poorly bonded together in terms of optical alignment (also referred to as optical axis adjustment, and hereinbelow, referred to as alignment), the optical performance of the bonded optical members is degraded. From this point of view, Patent Document 1 has proposed a method wherein bonding is done while making alignment by a fine assembly stage.

Although the method proposed by Patent Document 1 is suited for final alignment of optical members, which have been aligned to some extent, it is substantially difficult to make final alignment unless rough alignment (hereinbelow, referred to as initial alignment) has been made at the time of bonding. An additional problem has arisen in terms of highly skilled work being needed to make even initial alignment.

On the other hand, if a surface to apply the above-mentioned adhesive thereon (hereinbelow, referred to as bonded surface) is poorly cleaned, there is the possibility that an optical element fails to exhibit sufficient optical performance since the adhesive involves bubbles at the time of bonding, or there is the possibility that separation is made since the bonding strength of the bonded surface is not sufficient. From this point of view, it is necessary to sufficiently clean the bonded surface. As the method for cleaning optical glass members, there have been proposed a method for carrying out ultrasonic cleaning by a cleaning liquid with powder mixed thereinto (Patent Document 2), a photo-cleaning using a combination of ultraviolet light and ozone or active oxygen (Patent Document 3), a method for carrying out plasma cleaning under reduced pressure (Patent Document 4) and the like. However, these cleaning methods have had the purpose of cleaning optical members as a whole.

Even in a case where the bonded surface can be sufficiently cleaned, if the initial alignment needs a long time because of being difficult to be simply made, there is the possibility that the cleaned surface is contaminated again during the initial alignment. This means that additional equipment for preventing contaminations is needed and that it is impossible to increase productivity since the initial alignment requires a lot of skill. Neither the above-mentioned references nor the other references have proposed a method, which is capable of not only sufficiently cleaning a bonded surface but also easily making the initial alignment.

Patent Document 1: JP-A-07-002550 (pages 1 and 2, FIG. 1)

Patent Document 2: JP-A-06-126260 (pages 1 and 2, FIG. 1)

Patent Document 3: JP-A-2000-162402 (pages 1 to 3)

Patent Document 4: JP-A-2003-119054 (pages 1 to 4, FIG. 1)

### SUMMARY OF THE INVENTION

It is an object of the present invention to provide a method for producing an optical element by bonding a plurality of optical member with an adhesive, which is capable of providing the optical element with sufficient optical performance and with such a sufficient bonding strength to prevent separation from being made at bonded portions, and of making alignment easily.

The present invention provides a method for producing an optical element comprising bonding two or more optical members with an adhesive; wherein at least one of confronting bonded surfaces on at least one pair of contact surfaces of the optical members is subjected to dry cleaning in such a state that at least a surface connecting to the at least one bonded surface is masked, followed by applying a liquid adhesive as the adhesive on the cleaned surface and curing the liquid adhesive to bond the optical members.

The present invention also provides a method for bonding two optical members with a liquid adhesive, wherein respective bonded surfaces of the optical members are configured so as to be more easily wetted by the liquid adhesive than other surfaces of the optical members, and wherein when the liquid adhesive is applied on a bonded surface to bond both optical members, both optical members are relatively positioned each other by surface tension of the liquid adhesive.

In accordance with the method for producing an optical element, according to the present invention (hereinbelow, referred as the method according to the present invention), at least one of bonded surfaces of optical members to be bonded together with an adhesive is subjected to dry cleaning, such as plasma irradiation or ultraviolet irradiation, in such a state that at least a surface connecting to the at least one bonded surface is masked, followed by applying the adhesive on the cleaned surface. Thus, only the at least one bonded surface is selectively wetted by the liquid adhesive while the masked surface connecting to the at least one bonded surface is prevented from being wetted by the adhesive.

When an optical member, only the bonded surface of which has been selectively wetted, is bonded with its counterpart by the liquid adhesive, both optical members are automatically aligned with each other by surface tension of the liquid adhesive (hereinbelow, referred to as self-alignment). For this reason, the method according to the present invention does not need to carry out initial alignment, which requires skilled work. When the alignment accuracy of the optical members to be bonded together is not so sever, productivity is significantly improved since the final alignment process is not needed, or the final alignment process can be significantly simplified.

In the method according to the present invention, the optical elements are less limited in terms of material, size, shape and the like since the optical members to be bonded together can be automatically subjected to self-alignment. Accordingly, even optical members to be difficult to be aligned, such as glass lenses having a small size, can be easily bonded together, being aligned with each other. The method according to the present invention is excellent at productivity since bonding and alignment can be simultaneously and simply carried out.

In the method according to the present invention, since the at least one bonded surface of optical members is subjected to dry cleaning, such as plasma irradiation or ultraviolet irradiation, contaminations, such as organic substances, can be fully removed, with the result that not only the bonded surfaces can have a sufficient bonding strength but also the produced optical element can be provided with sufficient optical performance. When ultrasonic cleaning is done before dry cleaning, such as plasma irradiation or ultraviolet irradiation, the bonding strength or the optical performance can be more reliably ensured.

In some cases, a liquid adhesive, the bonding force of which is not so strong, needs to be used in consideration of the optical characteristics of the liquid adhesive, depending on how to use the optical element. Even in such cases, it is possible to ensure a sufficient bonding force.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view showing an example of how to mask an optical member in the method according to the present invention;

FIG. 2 is a schematic view showing another example of how to mask an optical member in the method according to the present invention;

FIGS. 3(a) to (d) are schematic views showing self-alignment;

FIG. 4 is an example of the process flowchart of the method according to the present invention;

FIG. 5 is a schematic cross-sectional view of an optical element produced by the method according to the present invention;

FIG. 6 is a schematic cross-sectional view showing optical members to be subjected to the method according to the present invention; and

FIG. 7 is a schematic view showing an optical member, which is subjected to plasma irradiation at atmospheric pressure in an example of the method according to the present invention.

### EXPLANATION OF THE REFERENCE NUMERALS

1: Convex lens as bonding object

1a and 2a: Bonded surface

1b and 2b: Connecting surface

1c and 2c: Outer periphery

1d and 2d: Optical surface other than bonded surface

1e and 2e: Optical axis

1f: Portion close to outer periphery 1c of bonded surface 1a (peripheral portion, which has no optical function)

1g and 2g: Dry cleaned portion

2: Meniscus lens as counterpart to be bonded

2f: Portion close to outer periphery 2c of bonded surface 2a (peripheral portion, which has no optical function)

3: Masking material

4: Direction of radiation in plasma irradiation treatment or ultraviolet irradiation treatment

5: Liquid adhesive

6 and 7: Direction to shift meniscus lens 2 by self-alignment

8: Cured liquid adhesive

9: Plasma forming device

10: High frequency power source

11: Nozzle

12: Masking jig

13: Direction to convey masking jig

14: Plasma jet

100: Cemented lens

### DETAILED DESCRIPTION OF THE INVENTION

The method according to the present invention is directed to a method for producing an optical element by bonding two or more optical members with an adhesive, which is characterized in that at least one of confronting bonded surfaces on at least one pair of contact surfaces of the optical members is subjected to dry cleaning in such a state that at least a surface connecting to a bonded surface is masked, followed by applying a liquid adhesive as the adhesive on the cleaned surface and curing the liquid adhesive to bond the optical members. In the method according to the present invention, it is preferred that both confronting bonded surfaces on the at least one pair of contact surfaces be subjected to dry cleaning in such a state that at least surfaces connecting to the bonded surfaces are masked, followed by applying the liquid adhesive on the cleaned surfaces and curing the liquid adhesive to bond the optical members.

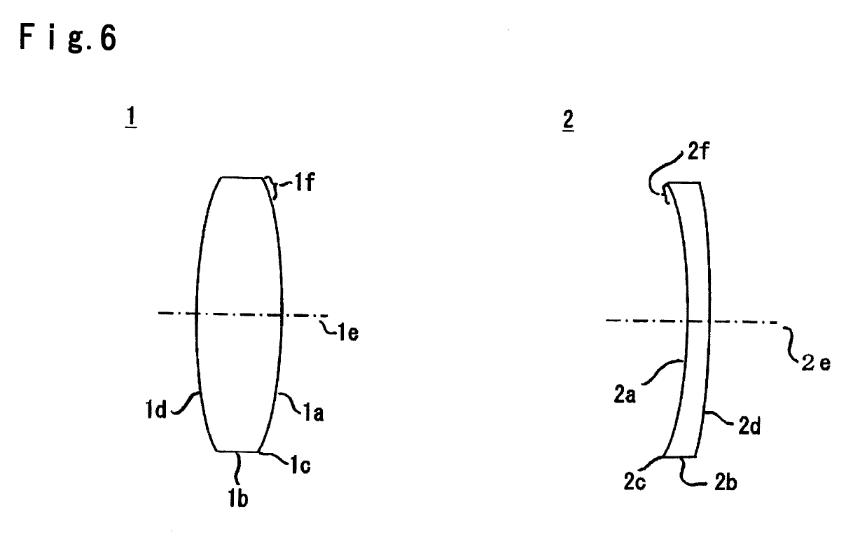

In the method according to the present invention, the above-mentioned surface that connects to a bonded surface is a surface, which is adjacent the bonded surface and shares an outer periphery with the bonded surface. For example, in FIG. 6, reference numeral 1 designates a convex lens as a bonded object, reference numeral 1a designates a bonded surface, reference numeral 1b designates a surface connecting to the bonded surface (hereinbelow, referred to as connecting surface), reference numeral 1c designates an outer periphery shared by the bonded surface and the connecting surface, reference numeral 1d designates an optical surface other than the bonded surface, and reference numeral 1e designates the optical axis of the convex lens. Further, reference numeral 2 designates a meniscus lens as the counterpart to be bonded with the convex lens 1, reference numeral 2a designates a bonded surface, reference numeral 2b designates a connecting surface, reference numeral 2c designates an outer periphery shared by the bonded surface and the connecting surface, reference numeral 2d designates an optical surface other than the bonded surface, and reference numeral 2e designates the optical axis of the meniscus lens.

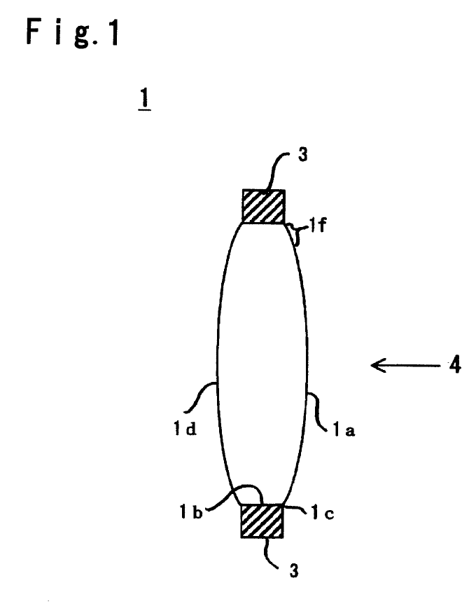

The method according to the present invention is characterized in that the bonded surface 1a is selectively subjected to dry cleaning, that is to say, only the bonded surface 1a is selectively subjected to dry cleaning. For this purpose, the connecting surface 1b, which shares the outer periphery 1c with the bonded surface 1a, is masked in order that the connecting surface is prevented from being subjected to dry cleaning. This state is shown in FIG. 1. In FIG. 1, the same portions as those shown in FIG. 6 are indicated by the same reference numerals, reference numeral 3 designates a masking material, and reference numeral 4 designates the direction of radiation in plasma irradiation treatment or ultraviolet irradiation treatment.

There are no limitations to the position, the nature and the like of the masking material as long as the bonded surface 1a subjected to dry cleaning is more wetted with a liquid adhesive than the connecting surface 1b not subjected to dry cleaning.

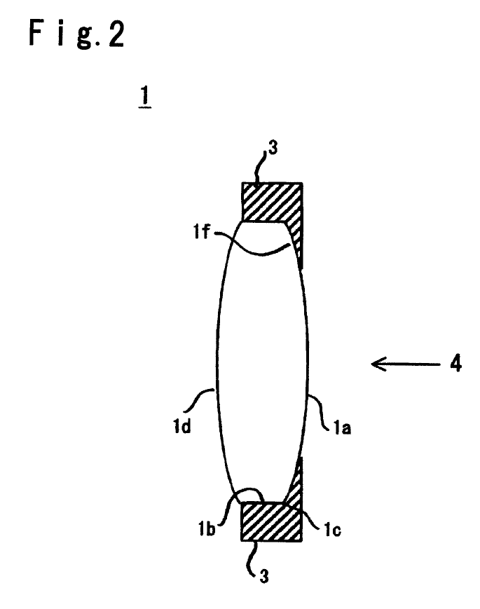

For example, with respect to a position to mask, as long as the self-alignment effect can be obtained, the masking material 3 does not need to be applied to the entire connecting surface 1b. The masking material 3 may be applied only to a portion of the connecting surface in the vicinity of the outer periphery 1c. When a portion 1f of the bonded surface 1a in the vicinity of the outer periphery 1c is not an optically effective surface, e.g., when the portion if is a portion covered by a lens barrel for housing the lens, the portion if, in addition to the connecting surface if, may be masked as shown in FIG. 2.

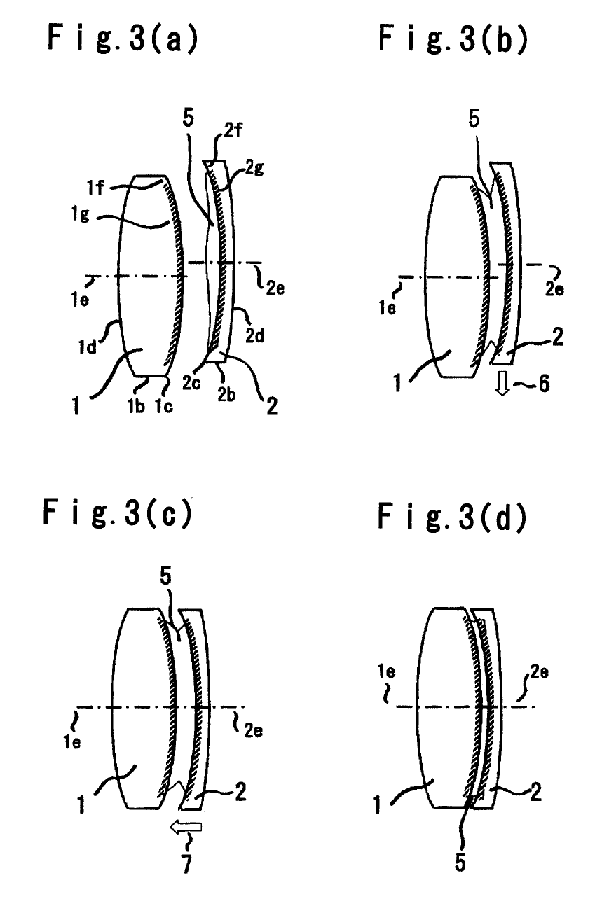

In FIG. 2, the same portions as those shown in FIG. 1 are indicated by the same reference numerals, and reference numeral if is designates the portion to be masked. With respect to FIG. 2, a schematic view explaining self-alignment is shown in FIG. 3. In FIGS. 3(a) to (d), the same portions as those shown in FIG. 1 and FIG. 2 are indicated by the same reference numerals, reference numeral 5 designates the liquid adhesive, reference numeral 6 and 7 designate the directions to shift the meniscus lens 2 by self-alignment, and hatched portions are portions subjected to dry cleaning.

FIG. 3(a) shows a state where the convex lens 1 has had only the optical effective surface of the bonded surface 1a subjected to dry cleaning, the meniscus lens 2 also has had only the optical effective surface of the bonded surface 2a subjected to dry cleaning, the liquid adhesive 5 has been dropped in a certain amount on a portion of the meniscus lens 2 subjected to dry cleaning, and the convex lens 1 has not been bonded with the meniscus lens 2 yet. In this state, the optical axis 1e of the convex lens 1 is out of alignment with the optical axis 2e of the meniscus lens 2. FIG. 3(c) shows a state where the surface tension of the liquid adhesive 5 has caused the meniscus lens 2 to be shifted in the directions indicated by the arrows 6 and 7, with the result that the optical axis 1e of the convex lens 1 and the optical axis 2e of the meniscus lens 2 have been accorded with each other by self-alignment. FIG. 3(d) shows a state where self-alignment has been completed.

It is preferred in terms of easy self-alignment that the surfaces of the optical members subjected to dry cleaning, i.e., the surfaces 1g and 2g shown in FIGS. 3(a) to (d) have the same area and the same shape as each other. It is particularly preferred that each of the surfaces subjected to dry cleaning be formed in a circular shape about the optical axis thereof. It is particularly preferred in terms of optical performance and self-alignment that the center of the surface 1g subjected to dry cleaning accord with the center of the bonded surface 1a and that the center of the surface 2g subjected to dry cleaning accords with the center of the bonded surface 2a.

Although the lenses are shown to be vertically put for simplification in FIGS. 3(a) to (d), the lenses are normally aligned with each other, being horizontally put. However, when each of the lenses is lightweight as in an extremely small-diameter lens, both lenses can be aligned with each other, being vertically put.

It is preferred from the viewpoint of providing the masked boundary with clearly different wettabilities to obtain a more significant self-alignment effect that the masking material have a property of repelling the liquid adhesive. The above-mentioned masking material preferably comprises only a fluororesin resin, silicone resin, polyimide resin or polyolefin resin film or sheet, or a combination of such a film or sheet with another material.

An example of the other material than the above-mentioned resins is metal, such as iron, aluminum or brass. When using such metal, it is preferred that a water-repellent and oil-repellent film or the like be formed on the surface of the metal. When dry cleaning is done by plasma processing under reduced pressure, it is preferred in terms of the stability of plasma that the other material than the above-mentioned resins be provided with electrical insulation in addition to a property of repelling the liquid adhesive 5. The masking material is preferably set as a masking jig since a job, such as winding of a film every time, can be eliminated and since productivity is improved.

In the method according to the present invention, it is preferred from the viewpoint of making dry cleaning more effective that before being subjected to dry cleaning, optical members be subjected to ultrasonic cleaning using a cleaning liquid, such as a mild detergent, an alkaline solution, or an organic solvent. When optical members have been subjected to ultrasonic cleaning, it is preferred that the optical members be dried by a drying process, such as spin-drying, blow-drying using a dry gas, drying under reduced pressure or drying by heating, as required.

In the method according to the present invention, there is no particular limitation to dry cleaning as long as a significant difference in the wettability of the liquid adhesive can be caused on the boundary between the bonded surface 1a and the connecting surface 1b to obtain the self-alignment effect, as long as the optical members can be cleaned so as to be sufficiently bonded together, as long as the optical members can be prevented from being damage, and as long as no solution is used. However, examples of preferred treatment include plasma irradiation treatment and ultraviolet irradiation treatment in terms of detergency and workability.

An example of the ultraviolet irradiation treatment is a method for irradiating an object with an ultraviolet ray of a low-pressure mercury lamp in an oxygen-containing atmosphere. In this method, the ultraviolet ray generated by the low-pressure mercury lamp is absorbed into oxygen to produce ozone, further producing excited oxygen atoms having an extremely strong oxidizability, with the result that the excited oxygen atoms react with organic substances as the main contamination to scatter and remove the organic substances.

There is no limitation to the plasma irradiation treatment as long as the treatment uses plasma, which comprises particles, such as ions, electrons and radicals, in a mixed state because atoms have been excited in a gas, and which is active, keeping an electroneutral state, as a whole. The plasma irradiation treatment is more preferred than the ultraviolet irradiation treatment since the former has a higher productivity than the latter because of having a higher detergency, a higher cleaning capacity and a shorter treatment period.

The plasma irradiation treatment is classified broadly into treatment under reduced pressure and treatment at atmospheric pressure in terms of pressure. The treatment under reduced pressure is more suited for treatment to clean a large amount of heavily contaminated members in terms of higher detergency and batch treatment.

On the other hand, the treatment at atmospheric pressure is more preferred because of having a mild detergency and minimizing damage to optical members in comparison with the treatment under reduced pressure, although it depends on what gas is used. From this point of view, the treatment at atmospheric pressure has an advantage of having a wider range of treatment conditions. Additionally, the treatment at atmospheric pressure has an extremely high productivity since optical members as objects to be treated can be put on a conveying stage, having the treatment surfaces facing upward to be dealt with at a conveying speed of, e.g., 10 to 200 mm/sec in an in-line process.

The gas used in the plasma processing preferably comprises a mixed gas of an inert gas and an oxygen gas. The content of the oxygen gas in the mixed gas is preferably 0.1 to 10 volume %. The content of the oxygen gas is preferably 5 to 10 volume % in treatment under reduced pressure. The content of the oxygen gas is preferably 0.5 to 3 volume % in treatment at atmospheric pressure. The content of the oxygen gas in the mixed gas is particularly preferably 0.7 to 2.5 volume % in treatment at atmospheric pressure.

The inert gas preferably comprises at least one selected from a rare gas, such as He, Ne, Ar, Kr, Xe or Rn, or a nitrogen gas. It is more preferred from the viewpoint of reducing the discharge starting voltage that the rare gas comprise He or Ar.

The other treatment conditions in the plasma processing, such as plasma forming conditions, are selected in conformity with the material, the size and the shape of optical members, the kind of the liquid adhesive, how to cure the adhesive, the degree of contamination of the optical members and the like, as required. In the method according to the present invention, optical members to be bonded together may be subjected to different types of dry cleaning, depending on the materials of the optical members. For example, an optical glass member, which has been subjected to plasma irradiation treatment, and an optical resin member, which have been subjected to ultraviolet irradiation treatment, may be bonded together.

In the method according to the present invention, the liquid adhesive 5, which is used to bond optical members, preferably comprises an organic material, which has necessary optical performance, has such an adequate elasticity to be capable of preventing separation even if deformation or a stress is caused, and has a short curing time. It is preferred from the viewpoint of enhancing the self-alignment effect that the liquid adhesive 5 have a lower viscosity and a greater surface tension. A preferred curing method is an ultraviolet curing method in terms of a reduction in the curing time. Examples of the liquid adhesive 5 include a photo-curable resin sensitive to, e.g., ultraviolet light, and a thermosetting resin. Specific examples include an epoxy resin, an acrylic resin, a polyene-polythiol resin, a fluorinated epoxy resin and a silicone resin.

In the method according to the present invention, there is no particular limitation to how the liquid adhesive 5 is applied to a portion subjected to dry cleaning. The liquid adhesive may be properly applied by, e.g., drop application or coating. After the liquid adhesive has been applied to a portion subjected to dry cleaning, the initial alignment is automatically completed since the self-alignment is done. After that, the final alignment is done as required, and then the liquid adhesive 5 between optical members to be bonded together is cured by a desired means, completing production of an optical element.

When an optical element is produced by using an adhesive to bond three or more of optical members, the method according to the present invention is applicable to one of the contact surfaces or all bonded surfaces of these optical members, i.e., the bonded surface of at least one of the contact surfaces.

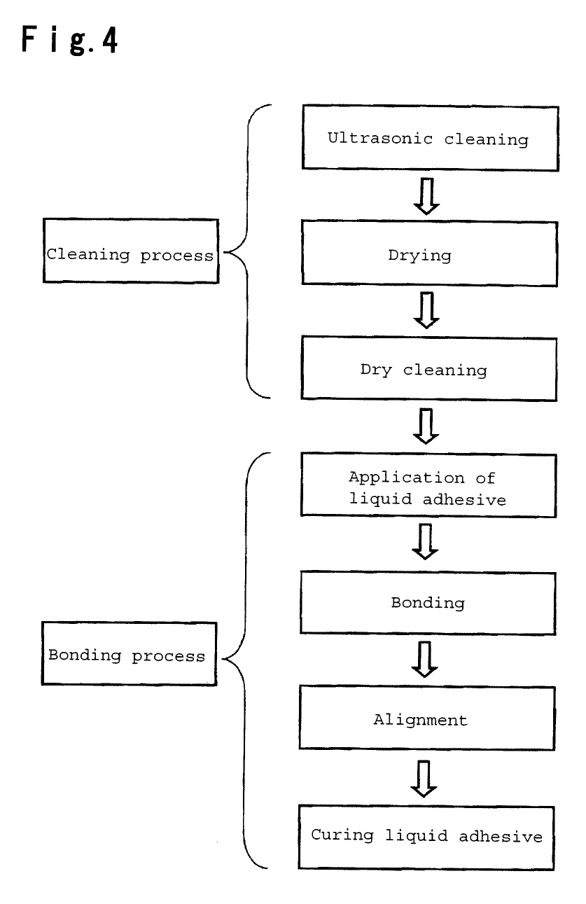

An example of the flowchart of a preferred process for the method according to the present invention is shown in FIG. 4. In FIG. 4, the entire process is classified broadly into a cleaning process and a bonding process. In the cleaning process, ultrasonic cleaning is carried out, followed by drying. These steps are repeated several times as required, followed by dry cleaning. It should be noted that a preparation step for cleaning, such as masking, is not shown in this flowchart.

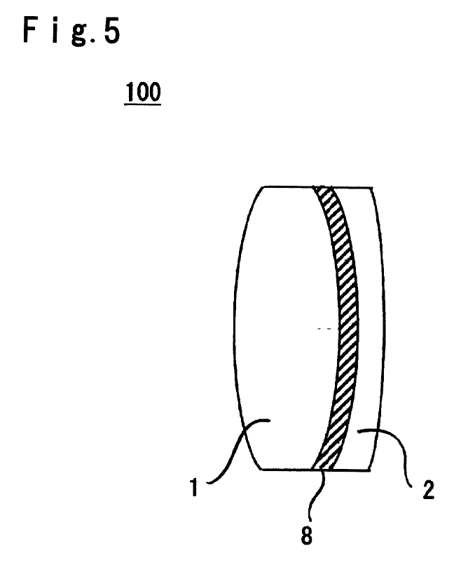

In the bonding process, the liquid adhesive is applied to the above-mentioned dry-cleaned portion, optical members are bonded together, the optical members are subjected to the initial alignment by the self-alignment effect, the optical members are subjected to the final alignment as required, and finally the liquid adhesive is cured, completing a sequential process. FIG. 5 is a schematic cross-sectional view of a cemented lens 100, which is produced by curing the liquid adhesive 5 after bonding the convex lens 1 and the meniscus lens 2 with the liquid adhesive 5 according to the flowchart.

In the method according to the present invention, there is no particular limitation to the material of each of optical members to be bonded together. Preferred examples of the material include an optical resin material and an optical glass material. The method according to the present invention is suitably applicable to not only bonding of members made of the same material, such as a combination of an optical resin member and an optical resin member, or a combination of an optical glass member and an optical glass member, but also bonding of members made of different materials, such as a combination of an optical resin member and an optical glass member. Preferred examples of the optical element produced by the method according to the present invention include a cemented lens, a prism, an optical filter and a diffraction grating. However, the optical element produced by the method according to the present invention is not limited to these products.

### EXAMPLE

In an example of the present invention, a cemented glass lens, which had an outer diameter of 10 mm and a total thickness of 5 mm, was produced so as to be capable of eliminating chromatic aberration with respect to different wavelengths. The cemented glass lens was configured so that the concave lens 2 was made of flint glass SF2, the convex lens 1 was made of crown glass BK7, and an acrylic, ultraviolet-curable adhesive was used as the liquid adhesive 5. The convex lens 1 and the concave lens 2 both had an outer diameter of 10 mm.

As the pretreatment for dry cleaning, a nitrogen gas was blown to the convex lens 1 and the concave lens 2 as the cemented lens parts to remove dust and dirt on the bonded surfaces. Then, the convex lens and the concave lens were subjected to ultrasonic cleaning, being immersed in 1) a cleaning liquid comprising a mild detergent, 2) a cleaning liquid comprising pure water, 3) a cleaning liquid comprising isopropyl alcohol, and 4) a cleaning liquid comprising acetone in 1 min in each of the cleaning liquids in this order. The ultrasonic cleaning process was repeated three times. In order to fully remove the moisture after blowing a nitrogen gas to dry the convex lens and the concave lens subjected to the ultrasonic cleaning process, the convex lens and the concave lens were heated and dried at 50° C. under reduced pressure (0.5 kPa).

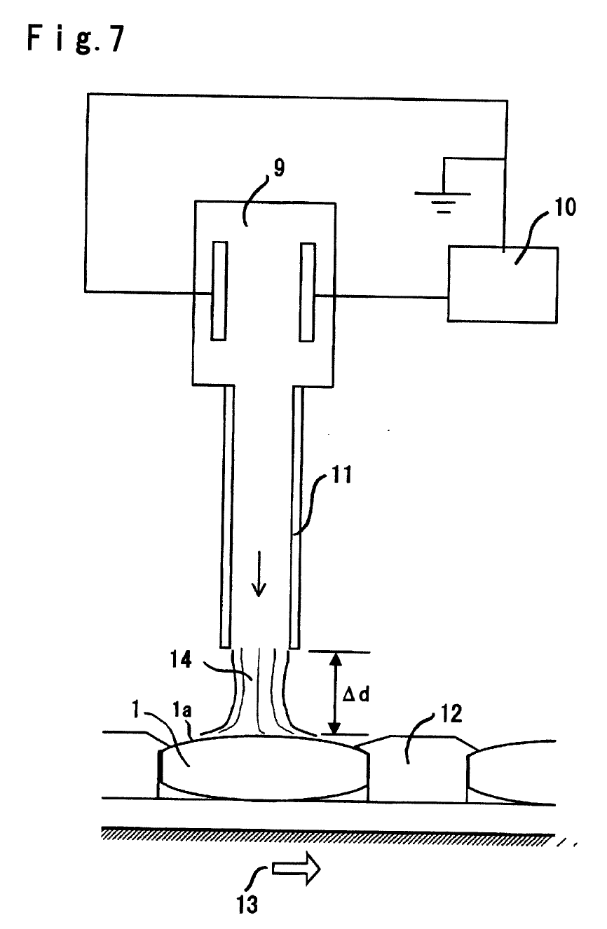

Next, an atmospheric plasma processing system, which used a processing gas having 1 volume % of oxygen gas mixed with an Ar gas, is shown in FIG. 7, was utilized, and plasma, which was formed by the processing gas and a high frequency power source 10 in a plasma forming device 9, was applied to the bonded surfaces of the respective lenses in the form of a plasma jet 14 from the leading edge of a nozzle 11 having a inner diameter 3 mm. Although the following explanation will be made about the dry cleaning process for the convex lens 1, the dry cleaning process was also applied to the concave lens 2 in the same way.

In this example, the surfaces other than the bonding surface 1a was masked with a masking jig 12 made of PTFE in order to prevent the plasma jet 14 from getting contact with the other surfaces. When the distance Ad between the leading edge of the nozzle 11 and the convex lens 1 is set in the range of 3 to 8 mm, the plasma processing can be uniformly. In this example, the distance was set at 5 mm, which made the particularly optimum treatment possible. Considering that the diameter of the plasma jet was about 5 mm in this plasma processing, the convex lens 1 was shifted under the plasma jet 14 at several times, being passed at a conveying speed of 30 mm/sec, so that the entire portion of the bonded surface 1a were subjected to the plasma processing. The result was that the contact angle of pure water on the bonded surface 1a had been an angle of 40 to 60 deg before the plasma processing, while the contact angle was an angle of 4 to 10 deg after the plasma processing. This reveals that the bonded surface 1a was sufficiently cleaned.

The coating amount of the liquid adhesive 5 was controlled so that the bonded adhesive layer had a thickness of 10 μm after the liquid adhesive was cured. The liquid adhesive 5 was coated in this amount on the bonded surface 2a of the concave lens 2, the bonded surface of the concave lens was bonded with the bonded surface 1a of the convex lens 1, and both lens were left as they were. The surface tension of the liquid adhesive caused both lens to be automatically and properly positioned with each other by self-alignment, with the result that the misalignment in the outer diameters of the concave lens and the convex lens was 10 μm. Finally, ultraviolet light was applied to cure the liquid adhesive 5, completing production of the cemented lens 100.

### INDUSTRIAL APPLICABILITY

The method according to the present invention is suited to a method for producing a large amount of optical elements since the alignment of optical members to be bonded together with an adhesive, which has required for skilled work, can be done in simple processing by self-alignment, which utilizes the surface tension of a liquid adhesive.

In the method according to the present invention, even an adhesive having a weak adhesive force can exhibit a sufficient bonding strength since optical surfaces to be bonded together are subjected to dry cleaning having a strong detergency. There are no residual contaminations, which form portions without an adhesive applied thereon, and there is no optical defect caused by, e.g., involved bubbles. As a result, it is possible to provide an optical element having a high quality.

The method according to the present invention utilizes the self-alignment effect, with the result that the method can flexibly cope with an optical element, which has a size or shape unsuitable for alignment using a stage.

The entire disclosure of Japanese Patent Application No. 2004-163103 filed on Jun. 1, 2004 including specification, claims, drawings and summary is incorporated herein by reference in its entirety.

What is claimed is:

1. A method for producing an optical element comprising bonding two or more optical members with an adhesive;
wherein at least one of confronting bonded surfaces on at least one pair of contact surfaces of the optical members is subjected to dry cleaning in such a state that at least a surface connecting to the at least one bonded surface is masked, followed by applying a liquid adhesive as the adhesive on the cleaned surface and curing the liquid adhesive to bond the optical members.

2. The method according to claim 1, wherein both confronting bonded surfaces are subjected to dry cleaning in such a state that at least surfaces connecting to the bonded surfaces are masked.

3. The method according to claim 1, wherein a peripheral portion of the at least one bonded surface, which has no optical function, is also masked.

4. The method according to claim 1, wherein the at least one bonded surface is masked by using a material having a property of repelling the liquid adhesive.

5. The method according to claim 1, wherein the optical members are subjected to ultrasonic cleaning as pretreatment of the dry cleaning.

6. The method according to claim 1, wherein portions to be subjected to dry cleaning, which are located on the confronting bonded surfaces of the plural optical members to be bonded together, have the same area and the same shape as each other.

7. The method according to claim 1, wherein the dry cleaning comprises plasma irradiation treatment or ultraviolet irradiation treatment.

8. The method according to claim 1, wherein the dry cleaning comprises plasma irradiation under reduced pressure or at atmospheric pressure.

9. The method according to claim 1, wherein at least one of the optical members comprises an optical glass member.

10. A method for boding two optical member with a liquid adhesive, wherein respective bonded surfaces of the optical members are configured so as to be more easily wetted by the liquid adhesive than the other surfaces of the optical member, and wherein when the liquid adhesive is applied on a bonded surface to bond both optical members, both optical members are relatively positioned each other by surface tension of the liquid adhesive.
